(19) United States
(12) Patent Application Publication
(10) Pub. No.: US 2011/0111369 A1
(43) Pub. Date: May 12, 2011

(54) Anchor and method

(76) Inventors: Zvi Laster, Poriya Elite (IL); Ole T. Jensen, Engelwood, CO (US); Meir Mamraev, Rishon Lezion (IL)

(21) Appl. No.: 12/926,036

(22) Filed: Oct. 22, 2010

Related U.S. Application Data
(60) Provisional application No. 61/280,583, filed on Nov. 6, 2009.

(51) Int. Cl. A61C 8/00

(52) U.S. Cl. 433/174

(57) ABSTRACT

An anchor is designed to thread-in an osseous tissue, and tends to resist unscrew and/or pull or extracting and/or pulling or extraction by featuring reverse flutes which, when attempting unscrew and/or pull or extracting and/or pulling or extraction, tends to develop an inwardly-directed equivalent force.

This application claims priority from U.S. Provisional Application Ser. No. 61/280,583, titled “Barb Implant”, filed Nov. 6, 2009.

### FIELD OF THE INVENTION

The present disclosure is mainly concerned with an anchor designed to be employed, by way of example only, to a living tissue, and, in particular, to a living bone. Potentially, such an anchor may removably receive a bolt, a screw and/or a stud, to fasten another component to the living bone and/or tissue.

### BACKGROUND

Anchors designed to removably receive a bolt, a screw and/or a stud, to fasten another component to the living bone and/or tissue, may unscrew and/or pull or extract as a result of trying loosening or attempting to remove the screw or bolt they may hold and/or a component fastened to the a bolt, a screw and/or a stud, and/or to the anchor.

U.S. Pat. No. 5,129,901 to Decoste Vern, titled “Cannulated Orthopedic Screw”, for example, discloses “A self-tapping, self-drilling cannulated screw, for orthopedic bone surgery, has tip, shank, threaded and head portions. The tip portion includes circumferentially spaced cutting points defining end surfaces which taper approximately 17 DEG relative to a perpendicular to the screw axis to butt the distal end of the cutting edge of a cutting flute. The cutting flutes are formed at circumferentially spaced positions about the screw adjacent the tip portion and, upon insertion of the screw, efficiently direct chips through the threaded portions and past the shank portion. Reverse cutting flutes are provided at the opposite end of the threaded portion for cutting and forming threads upon unthreading and hence removal of the screw from the bone when healed.”

Further, U.S. Pat. No. 5,129,901 discloses “A pair of cutting flutes 26 are formed in the threaded portion 22 adjacent the tip portion 20 and extend generally axially, terminating in the tip portion 20. It will be appreciated that more than two cutting flutes 26 may be provided and that the cutting flutes 26 are for purposes of cutting the bone to form screw threads, i.e., to tap the bone upon threading action of the cannulated screw into the bone. Each flute 26 interrupts a number of the threads of the threaded portion 22 and includes a generally radially extending wall 28 which serves as a cutting edge upon clockwise threading rotation of the screw into the bone. Wall 28 has an outer edge conforming to its intersection with the exterior surface of the threaded portion 22 whereby a tapped opening can be formed upon threading the screw 14 into the bone. The cutting edge 28 is also curved in the direction of rotation of the screw when threading the screw into the bone. The base 30 of each flute 26 extends along a chord line of the annular screw, as best illustrated in FIG. 3 . . . ”

“ . . . At the opposite end of the threaded portion 22 from the tip of the screw, there is provided at least a pair of reverse cutting flutes 40. The reverse cutting flutes 40 are circumferentially spaced one from the other and, similarly as flutes 26, each comprises a radial cutting edge 42 and a flat 44 formed along a chord of the annular screw. Thus, radial cutting edge 42 is effective upon counterclockwise unthreading action of the screw to cut the healed bone, facilitating tapping of the screw whereby the screw may be readily removed from the bone. The cutting edge 42 is curved at its opposite ends to channel the chips into the threaded portions 22 upon removal of the screw.”

However, anchors designed to receive a bolt or a screw may unscrew and/or pull or extract as a result of loosening the screw or bolt they hold.

Therefore, it would be desirable to have an anchor that, when attempting unscrew and/or pull or extracting and/or pulling or extraction, will tend to resist it, so that when an unscrew and/or pull or extracting and/or pulling or extraction torque is being applied to it, will react by tending to screw deeper. Therefore, there may currently exist a need in the industry for an anchor and associated method that may tend to resist application of unscrew and/or pull or extracting and/or pulling or extraction torque applied thereto, by developing reaction forces whose equivalent force which may tend to be directed into the substrate to which the anchor is fastened. This may be attained with the subject matter in accordance with the claims.

### SUMMARY

In The following disclosure, aspects thereof are described and illustrated in conjunction with systems and methods which are meant to be exemplary and illustrative, not limiting in scope.

The present disclosure is broadly related to an anchor designed for implants, and more specifically for implants in human and/or animal tissue, and to a method associated with the aforementioned anchor. With respect to the anchor, it is a generally shaped as a self-tapping screw, which is capable of tapping into bone tissues during an implant procedure, and also capable of resisting, or tendering to resist, at least partially, unscrew and/or pull or extracting and/or pulling or extraction, after the implant has set (i.e., after osseointegration). The core components of the anchor are several thread wraps, some comprising at least one self-tapping notch and some additionally and/or alternatively comprising at least one reverse notch, designed to resist, if not entirely prevent, unscrewing and/or pulling or extraction.

This may generally be accomplished by forming the at least one reverse notch with a reverse tooth face which may be inclined relative to a longitudinal axis of the anchor so that when attempting to unscrew and/or pull or extract the anchor, a reaction force operating on the reverse tooth face as a result of the unscrewing torque and/or of the pulling or extraction force applied thereto, has an inwards directed force component which tends to force the anchor into the bone, thus alleviating unscrewing and/or pulling or extraction of the anchor. With respect to the associated method, the following steps are carried out: when applying an unscrew and/or pull or extracting and/or pulling or extraction torque to the anchor, tangential forces may develop; because of the reverse notch face may be negatively inclined relative to the longitudinal axis of the anchor, axial components of the tangential forces tend to be directed axially along the turning-in direction, thus alleviating at least some of the anchor's tendency to unscrew and/or pull or extract.

According to an aspect of the present disclosure, an anchor may be provided having an anchor body comprising an apical end, a distal end and a longitudinal axis L extending through the apical end and the distal end and defining an apical-to-distal direction and a turning-in direction about the longitudinal axis L, and comprising a plurality of thread wraps. Each of the plurality of thread wraps may have an apical flank, a distal flank, and a radially-outermost flank extending between the apical flank and the distal flank. At least one of the plurality of thread wraps having at least one self-tapping notch formed therein defining a self-tapping tooth face extending generally inwardly from the radially outermost flank and generally facing the turning-in direction. At least one of the plurality of thread wraps having at least one reverse notch formed therein defining a reverse tooth face extending generally inwardly from the radially-outermost flank and generally facing away from the turning-in direction. The reverse tooth face may comprise a rearward normal Nr which may be tilted towards the distal end of the anchor body.

Possibly, the self-tapping tooth face may have a forward normal Nf extending generally orthogonally to the longitudinal axis L.

Alternatively, the self-tapping tooth face may haves a forward normal Nf generally tilted towards the distal end of the anchor body.

Optionally, the reverse tooth face may be located on the same thread wrap on which the self-tapping tooth face is located.

Alternatively, the reverse tooth face is located on a different thread wrap on which the self-tapping tooth face is located.

Optionally, more than one thread wraps may be provided with the reverse tooth face.

Possibly, more than one thread wrap may be provided with the self-tapping tooth face.

Potentially, the reverse tooth faces may be located on a different thread wraps than the thread wraps on which the self-tapping thread faces are located.

Optionally, thread wraps on which the reverse tooth faces are located, may be disposed distally relative to the thread wraps on which the at least one self-tapping notch may be located.

Possibly, at least one of the plurality of thread wraps may comprise a plurality of self-tapping notches.

Further possibly, at least one of the plurality of thread wraps may comprise a plurality of reverse notches.

According to another aspect of the present disclosure, method of employing an anchor may be provided, comprising steps of: Providing an anchor having an anchor body comprising an apical end, a distal end and a longitudinal axis L extending through the apical end and the distal end and defining an apical-to-distal direction and a turning-in direction about the longitudinal axis L; Providing on the anchor body a plurality of thread wraps, each of the plurality of thread wraps having an apical flank, a distal flank, and a radially-outermost flank extending between the apical flank and the distal flank; Providing at least one of the plurality of thread wraps with at least one self-tapping notch formed therein defining a self-tapping tooth face extending generally inwardly from the radially outermost flank and generally facing the turning-in direction; Providing at least one of the plurality of thread wraps with at least one reverse notch formed therein defining a reverse tooth face extending generally inwardly from the radially-outermost flank and generally facing away from the turning-in direction, the reverse tooth face comprises a rearward normal Nr is tilted towards the distal end of the anchor body, and implanting the anchor body in an existing and/or prepared hole in a living tissue, so that under an unscrewing torque which may be applied to the anchor, unscrewing torque and/or pulling or extraction force, reactions develop by compression of the tissue on the reverse tooth face to negate the unscrewing torque and/or pulling or extraction force.

In addition to the exemplary aspects and embodiments described above, further aspects and embodiments will become apparent by reference to the figures and by study of the following detailed descriptions.

### BRIEF DESCRIPTION OF THE DRAWINGS

Exemplary embodiments are illustrated in referenced figures and drawings. It is intended that the embodiments and figures disclosed herein are to be considered illustrative rather than restrictive.

Reference will now be made to the accompanying drawings, in which:

FIG. 1 is a schematic perspective and partial sectional view of a anchor implanted in a patient's gingival or gums;

FIG. 2 is a schematic perspective view of the anchor seen on FIG. 1;

FIG. 3 is a perspective top view of the anchor seen on FIG. 1;

FIG. 4 is a partial section view of the implant seen on FIG. 1;

FIG. 5 is a schematic partial perspective view of the anchor shown in FIG. 1;

FIG. 6 is a schematic partial enlarged perspective view of the anchor shown in FIG. 1, schematically illustrating forces which may act on the anchor.

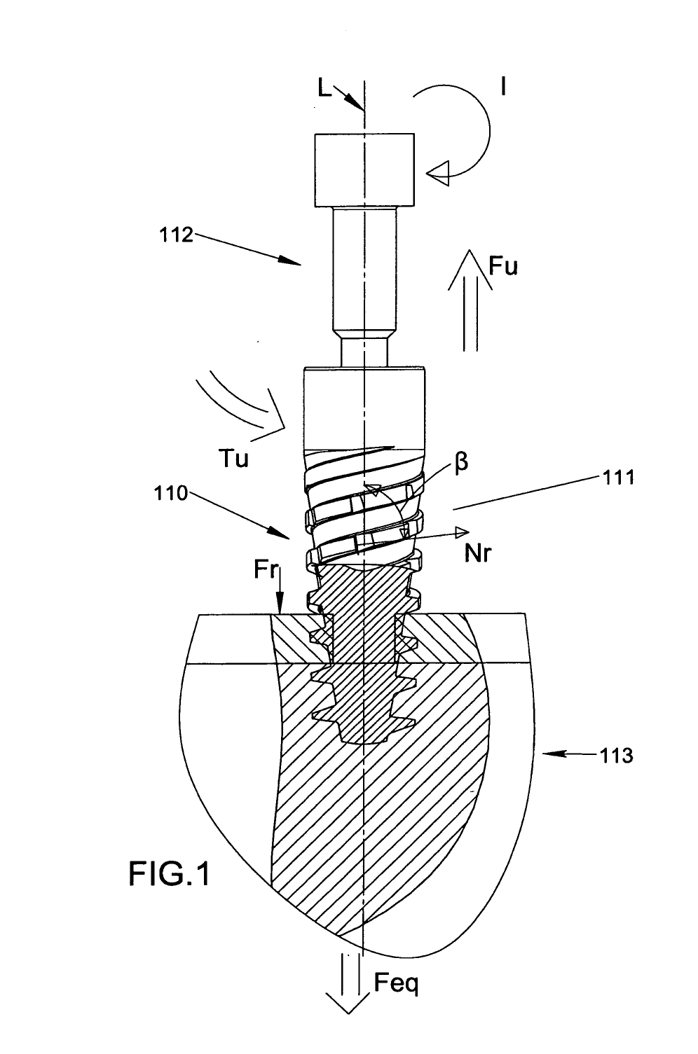

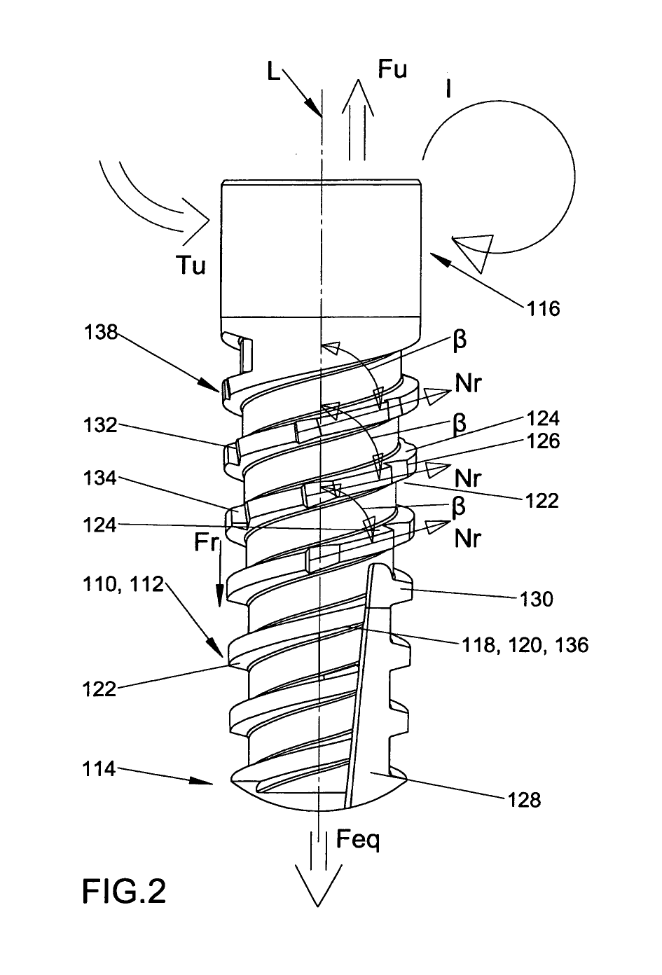

### DETAILED DESCRIPTION

Attention is drawn to the Figs. An anchor 110 may have an anchor body 111 which may releasably secure a screw or a bolt 112 and may be implanted in a substrate 113. For illustrative purposes only, such substrates 113 may include, but are not limited to, bone or osseous tissues (see http://en.wikipedia.org/wiki/Bone tissue, http://en.wikipedia.org/wiki/Osseous tissue, incorporated herein by reference). The anchor body 111 comprises an apical end 114 and a distal end 116. A longitudinal axis L extends through the apical end 114 and the distal end 116. A turning-in direction I is defined about the longitudinal axis L. The anchor body 111 may have a thread 118 comprising a plurality of thread wraps 120. Each of the plurality of thread wraps 120 has an apical flank 122, a distal flank 124, and a radial-outer flank 126 extending therebetween. One of the plurality of thread wraps 120 may comprises at least one self-tapping notch 128 formed therein. The at least one self-tapping notch 128 defines a forward tooth face 130 having a forward normal Nf facing generally tangentially forwardly relative to the turning-in direction I. The forward normal Nf may be disposed at a self-tapping angle α to the longitudinal axis L. The self-tapping angle α may be neutral, i.e., at a right-angle to the longitudinal axis L, or, in other words, having the forward normal Nf extending generally orthogonally to the longitudinal axis L. Alternatively, the forward normal Nf may be positively-inclined relative to the longitudinal axis L, i.e., tilted towards the distal end 116 of the anchor body 111.

One of the plurality of thread wraps 120 may additionally and/or alternatively comprise at least one reverse notch 132 formed therein. The at least one reverse notch 132 defines a reverse tooth face 134 having a rearward normal Nr facing tangentially rearwardly relative to the turning-in direction I. The rearward normal Nr may be disposed at a reverse angle β to the longitudinal axis L. The reverse angle β may be negatively-inclined relative to the longitudinal axis L, i.e., tilted towards the distal end 116 of the anchor body 111. Optionally, the at least one self-tapping notch 128 may be located on a same thread wrap 120 as the thread wrap 120 on which the at least one reverse notch 132 may be located. Possibly, the at least one self-tapping notch 128 may be located on a different thread wrap 120 than the thread wrap 120 on which the At least one reverse notch 132 may be located. Further possibly, the at least one of the two thread wraps 120 on which the at least one self-tapping notch 128 is located, may be hencetoforth called a self-tapping thread wrap 136. Similarly, one of the two thread wraps 120 on which the at least one reverse notch 132 may be additionally and/or alternatively located, may be hencetoforth called a reverse thread wrap 138. The self-tapping thread wrap 136 and the reverse thread wrap 138 may be the same thread wrap, or alternatively two distinct thread wraps.

The anchor may potentially be further provided with more than one self-tapping thread wrap 136 and also further potentially with more than one reverse thread wrap 138. The at least one reverse notch 132 may be located on different thread wraps 120 than the at least one self-tapping notch 128. Further possibly, the at least one reverse thread wrap 138 may be disposed distally relative to the at least one self-tapping thread wrap 136. Further potentially, the at least one self-tapping notch 128 may penetrate the anchor body 111. Also, further potentially, each self-tapping thread wrap 136 may comprise a plurality of self-tapping notches 128. Similarly, each reverse thread wrap 138 may comprise a plurality of reverse notches 132. Moreover, each of the at least one self-tapping thread wrap 136 may comprise a plurality of self-tapping notches 128, while each of the at least one reverse thread wrap 138 may comprise a plurality of reverse notches 132.

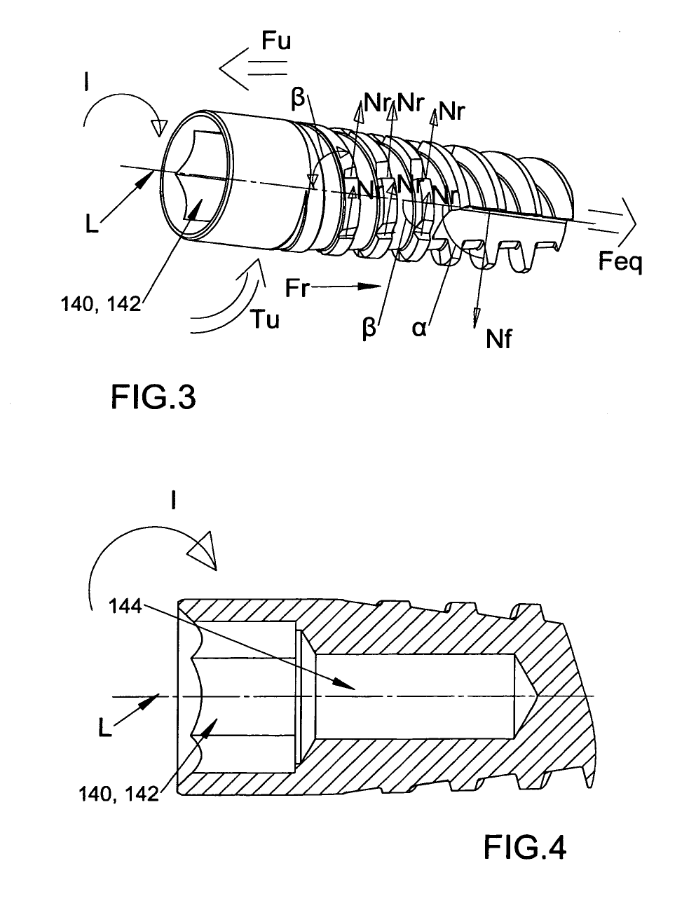

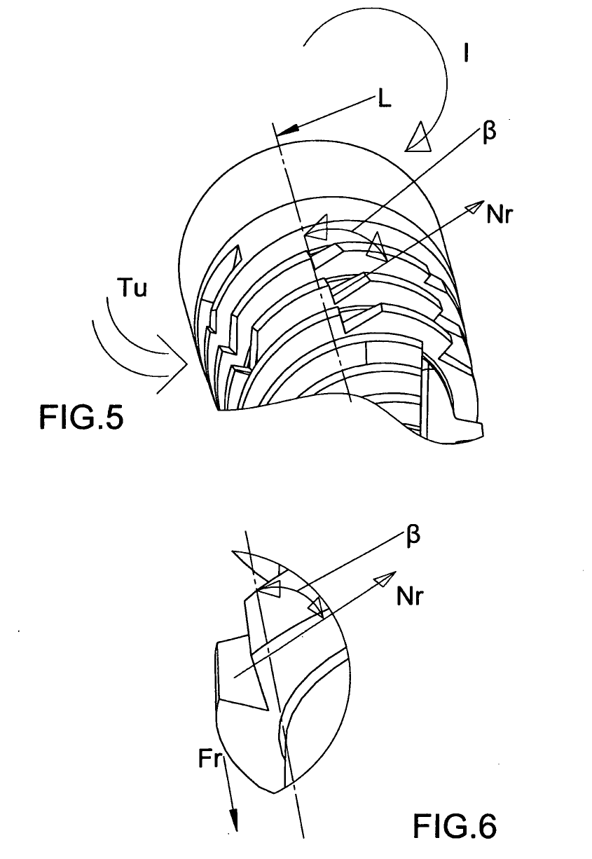

As may be best seen in FIGS. 3 and 4, the anchor body 111 may have an impression 140 at its distal end 116, possibly a hex-shaped socket 142. Additionally, the anchor body may be formed with a threaded receptacle to 144 to receive a threaded screw or bolt 112.

When the anchor body 111 goes through osseointegration (see http://en.wikipedia.org/wiki/Osseointegration, incorporated herein by reference, in its entirety), the reverse thread wraps 138 may be immersed in healed and/or healing osseous tissue, with the reverse tooth face or faces 134 bearing against the tissue. Thus, when, for example, a mechanical, unscrewing torque Tu and/or pulling or extraction force Fu may be applied to the anchor 110, particularly to the screw or bolt 112, which may tend to rotate the anchor 110 in a direction opposite to the turning-in direction I, the reverse tooth face or faces 134 may bear a reaction Fr by compression of the osseous tissue. Since the reverse tooth face or faces 134, which may be tilted in relation to the longitudinal axis L at the reverse angle β, the reaction Fr which may operate in an inward direction, may effect an equivalent reaction force Feq which may act to resist an outwards movement of the anchor 110. This may have the effect of relying on compression strength of the healing and/or healed tissue to negate the unscrewing torque Tu and/or extraction force Fu, instead of relying on shear forces between the anchor body 111 and the substrate 113. As is well known in the art, compression strength of healed, and particularly of healing, tissues, may be considerably greater than those developed by shear between the anchor body 111 and the substrate 113. Thus enhanced performance, stability, and resistance to pulling and/or unscrewing of the anchor 110 may be provided.

All directional references (such as, but not limited to, upper, lower, upward, downward, left, right, leftward, rightward, top, bottom, above, below, vertical, horizontal, clockwise, and counter-clockwise, tangential, axial and/or radial, or any other directional and/or similar references) are only used for identification purposes to aid the reader's understanding of the embodiments of the present disclosure, and may not create any limitations, particularly as to the position, orientation, or use unless specifically set forth in the claims. Similarly, joinder references (such as, but not limited to, attached, coupled, connect, accommodate and the like and their derivatives) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

While an exemplary embodiment has been described and shown in the accompanying drawings, it is to be understood that such an embodiment is merely illustrative of and not restrictive on the broad present disclosure, and that this disclosure may not be limited to the specific constructions and arrangements shown and described, since various other modifications and/or adaptations may occur to those of ordinary skill in the art. It is to be understood that individual features shown or described for the exemplary embodiment in the context of functional elements and such features may be replicated, or be omitted within the scope of the present disclosure and without departing from the spirit of the present disclosure as may be defined in the appended claims.

1. An anchor having an anchor body comprising an apical end, a distal end and a longitudinal axis L extending through the apical end and the distal end and defining an apical-to-distal direction and a turning-in direction about the longitudinal axis L, and comprising a plurality of thread wraps, each of the plurality of thread wraps having an apical flank, a distal flank, and a radially-outermost flank extending between the apical flank and the distal flank, at least one of the plurality of thread wraps having a self-tapping notch formed therein defining a self-tapping tooth face extending generally inwardly from the radially outermost flank and generally facing the turning-in direction, at least one of the plurality of thread wraps having a reverse notch formed therein defining a reverse tooth face extending generally inwardly from the radially-outermost flank and generally facing away from the turning-in direction, wherein the reverse tooth face comprises a rearward normal Nr is tilted towards the distal end of the anchor body.

2. The anchor of claim 1, wherein the self-tapping tooth face has a forward normal Nf extending generally orthogonally to the longitudinal axis L.

3. The anchor of claim 1, wherein the self-tapping tooth face has a forward normal Nf generally tilted towards the distal end of the anchor body.

4. The anchor of claim 1, wherein the reverse tooth face is located on the same thread wrap on which the self-tapping tooth face is located.

5. The anchor of claim 1, wherein the reverse tooth face is located on a different thread wrap on which the self-tapping tooth face is located.

6. The anchor of claim 1, comprising more than one thread wraps provided with the reverse tooth face.

7. The anchor of claim 1 comprising more than one thread wrap provided with the self-tapping tooth face.

8. The anchor of claim 1, wherein the reverse tooth faces are located on a different thread wrap than the thread wrap on which the self-tapping thread faces are located.

9. The anchor of claim 8, wherein the thread wraps on which the reverse tooth faces are located, are disposed distally, relative to the thread wraps on which the self-tapping notches are located.

10. The anchor of claim 1, wherein at least one of the plurality of thread wraps comprises a plurality of self-tapping notches.

11. The anchor of claim 1, wherein at least one of the plurality of thread wraps comprises a plurality of reverse notches.

12. A method of employing an anchor, comprising steps of:
a. Providing an anchor having an anchor body comprising an apical end, a distal end and a longitudinal axis L extending through the apical end and the distal end and defining an apical-to-distal direction and a turning-in direction about the longitudinal axis L;
b. Providing on the anchor body a plurality of thread wraps, each of the plurality of thread wraps having an apical flank, a distal flank, and a radially-outermost flank extending between the apical flank and the distal flank;
c. Providing at least one of the plurality of thread wraps with at least one self-tapping notch formed therein defining a self-tapping tooth face extending generally inwardly from the radially outermost flank and generally facing the turning-in direction;
d. Providing at least one of the plurality of thread wraps with at least one reverse notch formed therein defining a reverse tooth face extending generally inwardly from the radially-outermost flank and generally facing away from the turning-in direction, the reverse tooth face comprises a rearward normal Nr is tilted towards the distal end of the anchor body;
e. Implanting the anchor body in an existing and/or prepared hole in a living tissue; wherein
f. Under an unscrewing torque being applied to the anchor, unscrewing torque and/or pulling or extraction force, reactions develop by compression of the tissue on the reverse tooth face to negate the unscrewing torque and/or pulling or extraction force.

13. The method of claim 12, comprising a step of providing the self-tapping tooth face has a forward normal Nf generally tilted towards the distal end of the anchor body.

14. The method of claim 12, comprising a step of providing the reverse tooth face on the same thread wrap on which the self-tapping tooth face is provided.

15. The method of claim 12, comprising a step of providing the reverse tooth face on a different thread wrap on which the self-tapping tooth face is located.

16. The method of claim 12, comprising a step of providing more than one thread wraps with the reverse tooth face.

17. The method of claim 16, comprising a step of locating the reverse tooth faces on a different thread wraps than the thread wraps on which the self-tapping thread faces are located.

18. The method of claim 17, comprising a step of providing the thread wraps on which the reverse tooth faces are located distally relative to the thread wraps on which the self-tapping notches are located.

19. The method of claim 12, comprising a step of providing at least one of the plurality of thread wraps with a plurality of self-tapping notches.

20. The method of claim 12, comprising a step of providing at least one of the plurality of thread wraps with a plurality of reverse notches.
